(19) United States
(12) Patent Application Publication
(10) Pub. No.: US 2009/0203261 A1
(43) Pub. Date: Aug. 13, 2009

(54) CONNECTOR FOR STANDARD HDMI CABLE

(76) Inventors: Fumihito IKEGAMI, Ichikawa-shi (JP); Hiroshi Takahira, Kawasaki-shi (JP); Shunsuke Morita, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/369,435

(22) Filed: Feb. 11, 2009

(30) Foreign Application Priority Data
Feb. 13, 2008 (JP) 2008-032222

(51) Int. Cl. H01R 31/06

(52) U.S. Cl. 439/628

(57) ABSTRACT

A connector for a cable based on the HDMI standard includes contact terminals having contact pads arranged on a top surface of an insulator portion connected to signal lines of a connecting portion of a plug. Resilient pieces of the contact terminals are disposed adjacent to grounding lines and disposed in grooves of an adaptor housing with an insulator adjacent to each other to form a pair of signal lines. The connector also includes contact portions electrically connected to the contact pads of a flexible wiring board of an adaptor section.

This application claims the benefit of Japanese Patent Application No. 2008-032222, filed Feb. 13, 2008, which is hereby incorporated by reference herein in its entirety.

### BACKGROUND OF THE INVENTION

1. Field of the Invention

The present invention relates to a HDMI cable connector which is detachably connected with a plug with a cable based on HDMI standard.

2. Description of the Related Art

Cables and connectors based on the HDMI (High-Definition Multimedia Interface which is a registered trademark) standards are in practical use to interconnect digital audio-visual equipment (hereinafter referred to as AV equipment). Since connection established using such a cable and a connector allows uncompressed digital picture and audio signals to be transferred at a transfer speed of about 10 Gbit/s (per one cable), more high-quality images and others can therefore be recorded and reproduced by the AV equipment.

Interconnection between AV equipment, e.g., interconnection between a digital-controlled amplifier and a display (television receiver) or between a digital-controlled amplifier and a DVD player may be connected by a cable and a connector based on the HDMI standards.

In such a case, as disclosed in Japanese Utility Model Registration No. 3113056, a connector is supported by, for example, a printed circuit board (a fixed body 40 in Japanese Utility Model Registration No. 3113056) and a housing of an apparatus.

Such a connector includes a receptacle which is disposed on the printed circuit board and which can be detachably connected with a connecting portion of a plug provided at one end of a cable integrally therewith.

A plug-connecting portion of the receptacle that is detachably connected with the connecting portion of the plug is exposed, for example, at a predetermined position of the housing of the AV equipment.

As disclosed in Japanese Patent Laid-Open No. 2002-334748, a plurality of connection contact portions belonging to a group of contact terminals comprising contact terminals for signals, contact terminals for grounding, and contact terminals for power supply are disposed on each of top and bottom surfaces of an insulator portion of the receptacle to which the connecting portion of the plug of the receptacle is detachably connected.

For example, as shown in FIG. 1 attached to Japanese Patent Laid-Open No. 2002-334748, the plurality of connection contact portions disposed on the top surface are a connection contact portion (S) for signals, another connection contact portion (S) for signals, a connection contact portion (G) for grounding, another connection contact portion (S) for signals, still another connection contact portion (S) for signals, and another connection contact portion (G) for grounding, etc. which are listed in order of their closeness from a right end of the top surface. The plurality of connection contact portions disposed on the bottom surface are a connection contact portion (G) for grounding, a connection contact portion (S) for signals, another connection contact portion (S) for signals, another connection contact portion (G) for grounding, still another connection contact portion (S) for signals, and still another connection contact portion (S) for signals, etc. which are listed in order of their closeness from a right end of the bottom surface. In that case, the connection contact portion (G) for grounding at the right end of the bottom surface is disposed in a position which corresponds to the gap between the first and second connection contact portion (S) for signals on the top surface. Therefore, the plurality of connection contact portions disposed on the top and bottom surfaces, respectively, are staggered relative to each other.

### SUMMARY OF THE INVENTION

When a receptacle of a connector is mounted in a housing of an AV equipment by the intervention of a printed circuit board as mentioned above, particularly, the position to dispose the receptacle may be limited to a rear side of the AV equipment because of a need for keeping a sufficient space to allow the printed circuit board to be disposed therein.

However, it might be desired to dispose the receptacle in a position, for example, in a front side or lateral side of the AV equipment without limiting the position to dispose the receptacle to the rear side of the housing of the AV equipment. In such a case, an alternative approach may be chosen to improve flexibility in designing the disposition of the receptacle.

Specifically, it may be considered that the receptacle is supported on the housing without using the printed circuit board as described above, and fixed-side terminals among the contact terminals provided in the receptacle are directly wired to a control circuit board through cables.

However, according to the HDMI standards (Version 1.3), since the distance between contact pads arranged in a row at a connecting portion is 0.4 or 0.5 mm, it may be therefore difficult to directly wire the connecting portion of the control circuit board to respective fixed-side terminals among the contact terminals through cables without increasing the pitch of the pads.

Each of fixed-side terminal portions continuous with connection contact portions for signals and connection contact portions for grounding among the group of contact terminals provided in the receptacle is soldered in a predetermined position on the printed circuit board. In that case, the fixed-side terminal portion continuous with the connection contact portion (S) for signals located at the right end of the top surface of the printed circuit board as described above and the fixed-side terminal portion continuous with the adjacent connection contact portion (S) for signals may be soldered apart from each other in such positions that they sandwich a fixed-side terminal portion continuous with the connection contact terminal (G) for grounding on the bottom surface when the printed circuit board is viewed from above.

In particular, when a differential transmission method is employed, it is desirable for better impedance matching that fixed-side terminal portions continuous with a pair of connection contact portions (S) for signals are disposed at a predetermined small distance from a fixed-side terminal continuous with a connection contact portion (S) adjacent to the pair of connection contact portions.

However, the impedance matching may be hindered when the fixed-side terminal portion continuous with the connection contact portion (S) for signals at the right end of the top surface as described above and the fixed-side terminal portion continuous with the adjacent connection contact portion (S) for signals are soldered part from each other on the printed circuit board in such positions that they sandwich the fixed-side terminal portion continuous with the connection contact terminal (G) for grounding at the right end of the bottom surface. A problem therefore arises, for example, in that a signal waveform-shaping element or a signal waveform-shaping circuit board may be required.

In view of the above-described mentioned problem, it is an object of the invention to provide a connector for a cable based on the HDMI standard which is detachably connected with a plug of a cable based on the HDMI standard. Connection terminals of a receptacle of the connector can be electrically connected to a control circuit board without increasing the pitch of the connection terminals of the receptacle using a printed circuit board, and impedance matching can be easily achieved.

To achieve the above-mentioned described object, a connector for a cable based on the HDMI standard according to the present invention comprises, a cable connecting portion to which a group of contact pads of a flexible cable are detachably connected directly or indirectly; a first transmission path forming surface and a second transmission path forming surface which a plurality of transmission paths are respectively arranged according to the HDMI standard on a plug-portion being connected to which a connecting portion of a plug connected with a cable based on the HDMI standard is detachably connected; a first contact terminal for grounding and a second contact terminal for grounding connected to one transmission path for grounding formed between a pair of transmission paths for signals and another pair of transmission paths for signals on each of the first transmission path forming surface and the second transmission path forming surface, the first contact terminal for grounding and the second contact terminal for grounding for electrical connecting with the cable; a first contact terminal for signals and a second contact terminal for signals connected to a pair of transmission paths for signals, respectively, on the first transmission path forming surface, the first contact terminal for signals and the second contact terminal for signals for electrical connecting with the cable; and a third contact terminal for signals and a fourth contact terminal for signals connected to a pair of transmission paths for signals, respectively, on the second transmission path forming surface, the third contact terminal for signals and the fourth contact terminal for signals for electrical connecting with the cable, wherein a contact portion of the first contact terminal for signals and a contact portion of the second contact terminal for signals are disposed adjacent to each other on a common plane of the cable-connecting portion, and a contact portion of the third contact terminal for signals and a contact portion of the fourth contact terminal for signals are disposed adjacent to each other on common plane of the cable-connecting portion, wherein a contact portion of the second contact terminal for grounding is disposed between either the contact portion of the first contact terminal for signals or the contact portion of the second contact terminal for signals and either the contact portion of the third contact terminal for signals or the contact portion of the fourth contact terminal for signals.

Further, a connector for a cable based on the HDMI standard according to the present invention comprises, a cable connecting portion to which a group of contact pads of a flexible cable are detachably connected directly or indirectly; a first transmission path forming surface and a second transmission path forming surface which a plurality of transmission paths are respectively arranged according to the HDMI standard on a plug-portion being connected to which a connecting portion of a plug connected with a cable based on the HDMI standard is detachably connected; a first contact terminal for grounding and a second contact terminal for grounding connected to one transmission path for grounding formed between a pair of transmission paths for signals and another pair of transmission paths for signals on each of the first transmission path forming surface and the second transmission path forming surface, the first contact terminal for grounding and the second contact terminal for grounding for electrical connecting with the cable; a first contact terminal for signals and a second contact terminal for signals connected to a pair of transmission paths for signals, respectively, on the first transmission path forming surface, the first contact terminal for signals and the second contact terminal for signals for electrical connecting with the cable; and a third contact terminal for signals and a fourth contact terminal for signals connected to a pair of transmission paths for signals, respectively, on the second transmission path forming surface, the third contact terminal for signals and the fourth contact terminal for signals for electrical connecting with the cable, wherein a contact portion of the first contact terminal for signals and a contact portion of the second contact terminal for signals are disposed adjacent to each other on a common plane of the cable-connecting portion, and a contact portion of the third contact terminal for signals and a contact portion of the fourth contact terminal for signals are disposed adjacent to each other on another common plane of the cable-connecting portion, and a contact portion of the first contact terminal for grounding is disposed between either the contact portion of the first contact terminal for signals or the contact portion of the second contact terminal for signals and either the contact portion of the third contact terminal for signals or the contact portion of the fourth contact terminal for signals, or the contact portion of the first contact terminal for grounding being disposed adjacent to the contact portion of either the third contact terminal for signals or the fourth contact terminal for signals.

Furthermore, a connector for a cable based on the HDMI standard according to the present invention may comprises,

the second contact terminal for grounding according to claim 1 and the first contact terminal for grounding according to claim 2.

According to a connector for a cable based on the HDMI standard of the present invention, the invention includes a cable connecting portion and a plug-portion being connected to which a connecting portion of a plug connected to a cable based on the HDMI standard is detachably connected. A contact portion of the first contact terminal for signals and a contact portion of the second contact terminal for signals are disposed adjacent to each other on a common plane of the cable-connecting portion, and a contact portion of the third contact terminal for signals and a contact portion of the fourth contact terminal for signals are disposed adjacent to each other on another common plane of the cable-connecting portion. Therefore, connection terminals of a receptacle can be electrically connected to a control circuit board without increasing the distance between the connection terminals of the receptacle. A contact portion of the second contact terminal for grounding is disposed between either the contact portion of the first contact terminal for signals or the contact portion of the second contact terminal for signals and either the contact portion of the third contact terminal for signals or the contact portion of the fourth contact terminal for signals. Therefore, impedance matching can be easily achieved.

Further features of the present invention will become apparent from the following description of exemplary embodiments (with reference to the attached drawings).

### BRIEF DESCRIPTION OF THE DRAWINGS

FIG. 1 is a perspective view showing an adaptor housing with an insulator used in a first embodiment of a connector for a cable based on the HDMI standard according to the present invention;

FIG. 2 is a perspective view showing the adaptor housing with an insulator shown in FIG. 1 as seen from the side of the insulator portion;

FIG. 3 is a front view of the adaptor housing with an insulator shown in FIG. 1;

FIG. 4 is a view showing the adaptor housing with an insulator shown in FIG. 1 as seen from the side of the insulator portion;

FIG. 5A is a plan view schematically showing a structure of the first embodiment of a connector for a cable based on the HDMI standard according to the present invention, when no adaptor portion is connected with the same;

FIG. 5B is a plan view schematically showing a structure of the first embodiment when an adaptor portion is connected with the same;

FIG. 6 is an enlarged plan view showing a receptacle used in the first embodiment of a connector for a cable based on the HDMI standard according to the present invention;

FIG. 7 is an enlarged plan view showing the adaptor portion used in the embodiment of a connector for a cable based on the HDMI standard according to the present invention;

FIG. 8 is a front view of the receptacle shown in FIG. 6;

FIG. 9 is a side view of the receptacle shown in FIG. 6;

FIG. 10 is a sectional view of the receptacle shown in FIG. 6;

FIG. 11 is a sectional view of the adaptor portion shown in FIG. 7;

FIG. 12 is a view of the receptacle in FIG. 6 as seen from the side of the adaptor connection portion;

FIG. 13 is a sectional view of the receptacle shown in FIG. 6;

FIG. 14 is a partial enlarged view of FIG. 13;

FIG. 15 is a sectional view taken along the line XV-XV in FIG. 9;

FIG. 16 is a partial enlarged view of FIG. 15;

FIG. 17 is a perspective view of contact terminals for signals used in the first embodiment and a second embodiment of a connector for a cable based on the HDMI standard according to the present invention;

FIG. 18 is a perspective view of contact terminals for signals used in the first embodiment and the second embodiment of a connector for a cable based on the HDMI standard according to the present invention;

FIG. 19 is a perspective view showing a state of manufacturing steps of the contact terminals shown in FIG. 17;

FIG. 20 is a perspective view showing a state of manufacturing steps of the contact terminals shown in FIG. 18;

FIG. 21 is a partial enlarged perspective view of a region A in FIG. 19;

FIG. 22 is a partial enlarged perspective view of a region B in FIG. 20;

FIG. 23 is a partial enlarged front view of the region B in FIG. 20;

FIG. 24 is a perspective view of contact terminals for grounding used in the first embodiment and the second embodiment of a connector for a cable based on the HDMI standard according to the present invention;

FIG. 25 is a perspective view of contact terminals for grounding used in the first embodiment and the second embodiment of a connector for a cable based on the HDMI standard according to the present invention;

FIGS. 26A and 26B are enlarged perspective views of a receptacle used in the second embodiment of a connector for a cable based on the HDMI standard according to the present invention, respectively; and

FIGS. 27A and 27B are sectional views of the receptacle in examples shown in FIGS. 26A and 26B, respectively.

### DESCRIPTION OF THE EMBODIMENTS

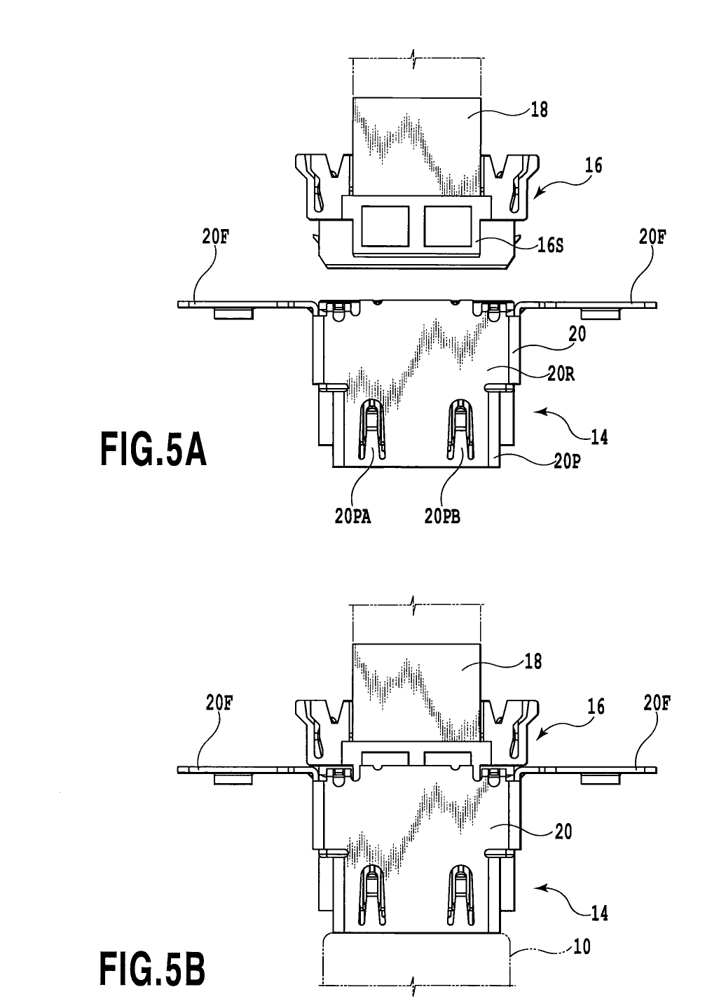

Each of FIGS. 5A and 5B shows a configuration of a first embodiment of a connector for a cable based on the HDMI standard according to the present invention.

The connector shown in FIGS. 5A and 5B is based on the definition of either Type A or Type B of the HDMI (High-Definition Multimedia Interface (registered trademark)) standard (Version 1.3).

Referring to FIG. 5A, the connector could say what is called an externally-connected connector. The connector includes an adaptor section 16 which is connected to one end of a flexible wiring board 18 serving as a flexible cable and which can be removably mounted in an adaptor housing of a receptacle 14 to be described later, and the receptacle 14 having the adaptor housing with an insulator, the adaptor housing having a plug-connecting portion which is detachably connected with a connecting portion of a plug 10 connected to one end of a cable (not shown) based on the HDMI standard.

One end of the plug 10 is connected with one end of the cable, and the plug 10 has the connecting portion at the other end thereof. The connecting portion has an insulator portion made of resin inside a metal shell of the connecting portion. In a central region inside the insulator portion, a slit is formed to be fitted with an insulator portion 22T of the receptacle 14. At an edge that defines the slit, a plurality of contact pins, which are to be put in contact with contact pad portions of a contact terminal to be described later, are disposed at predetermined equal intervals so as to surround the slit.

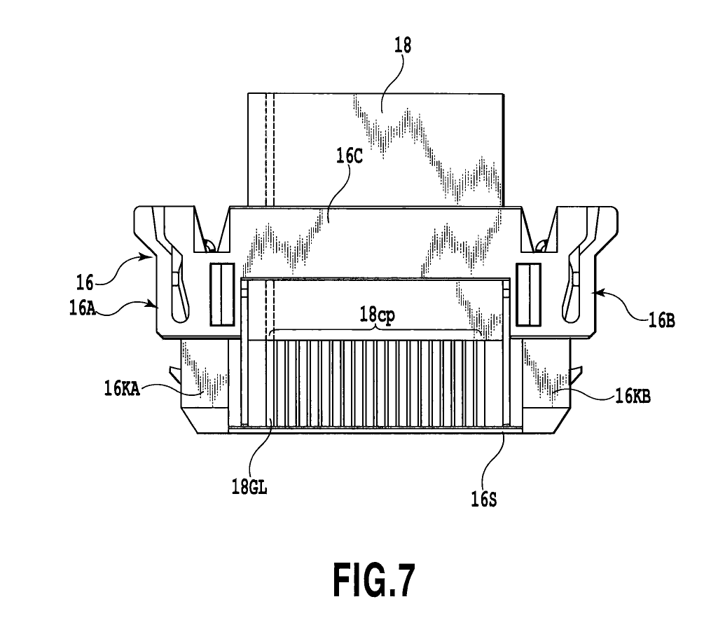

For example, the flexible wiring board 18 is constructed by forming a plurality of conductive layers covered with a protective layer on both sides of an insulating base. The insulating base is formed from, for example, a liquid crystal polymer (LCP), glass epoxy resin, polyimide (PI), polyethylene terephthalate (PET), or polyether imide (PEI) to a thickness of about 50 μm. The protective layer is formed by, for example, a thermosetting resist layer or a polyimide film. At one end of the flexible wiring board 18 which is to be connected to the adaptor section 16, a group of contact pads 18 cp (see FIG. 7) is formed. Each of contact pads constituting the contact pad group 18cp is formed in parallel with each other at predetermined intervals. Referring to FIG. 7, a ground line 18GL is formed in a position adjacent to the left end of the contact pad group 18cp along the direction in which the flexible wiring board 18 extends.

The adaptor section 16 is formed from, for example, a resin material. As shown enlarged in FIG. 7, the adaptor section 16 includes a combining portion 16S in the form of a thin plate which combines the contact pad group 18cp of the flexible wiring board 18, guide pins 16KA and 16KB which are formed integrally with two respective ends of the combining portion 16S and which are inserted in recesses of an adaptor housing portion to be described later, operating portions 16A and 16B which control the operation of a pair of lock springs 16PA to be described later, and a plate-like portion 16C which combines the operating portions 16A and 16B.

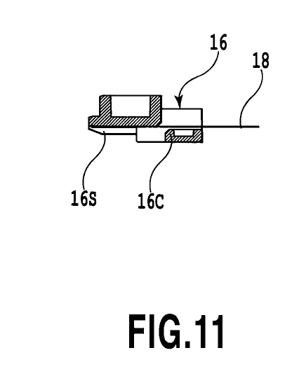

The combining portion 16S has a bonding surface to be bonded, the bonding surface to be bonded serving as a connecting surface that a surface coated with an adhesive of the flexible wiring board 18 is cemented. As shown in FIG. 11, a gap is formed between the combining portion 16S as a connecting end and the plate-like portion 16C to allow an end of the flexible wiring board 18 to be combined to pass. This causes the contact pad group 18cp of the flexible wiring board 18 bonded to the bonding surface to be bonded of the combining portion 16S to expose toward contact terminals in the adaptor housing having an insulator which will be described later, as shown in FIGS. 7 and 11. Both ends of the plate-like portion 16C are integrally connected with the parts being continuous with respective ends of the operating portions 16A and 16B.

The guide pins 16KA and 16KB have structures which are identical to each other, and the following description will address only the guide pin 16KA and will omit an explanation of the guide pin 16KB.

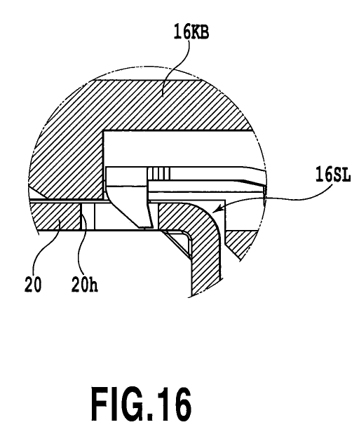

As shown partial enlarged in FIG. 16, the guide pin 16KA, which has a peak part at one end thereof, comprises a slit 16SL on a side surface thereof,

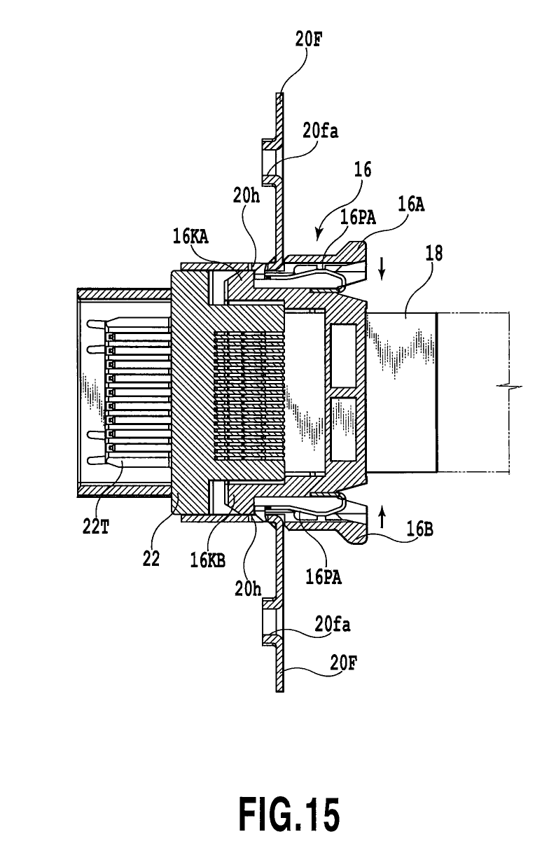

the slit through which a nib of a lock spring 16PA disposed inside the guide pin 16KA extends. A lock spring containing portion (not shown) is formed inside the guide pin 16KA and the operating portion 16A. The lock spring containing portion is in communication with the outside of the connector through an open end thereof where the lock spring 16PA is inserted and through the slit 16SL. One end of the operating portion 16A is formed integrally with the guide pin 16KA in the vicinity of a base part of the pin, while another end of the operating portion 16A is formed such that it can move in the direction indicated by the arrow in FIG. 15 when a peripheral part of the operating portion is pressed in the direction indicated by the arrow.

A pressing portion is formed on an inner circumferential surface of the lock spring containing section, the pressing portion being in contact with a curved part of the lock spring 16PA mounted in the lock spring containing section. When the operating portion 16A is pressed in the direction indicated by the arrow in FIG. 15 against a resilient force of the curved part of the lock spring 16PA, the pressing portion is moved to cause a movement of the curved part and the nib of the lock spring 16PA in the direction indicated by the arrow. On the contrary, when the press on the operating portion 16A is released, the pressing portion is returned to the initial state by a restoring force of the curved part of the lock spring 16PA.

The end of the nib of the lock spring 16PA protrudes outward from the slit 16SL described above. The lock spring 16PA includes a fixed part which is fixed in the lock spring containing section, the nib which is selectively engaged with an edge defining a hole 20h formed on an inner circumferential part of the recess of the adaptor housing section to be described later, and the curved part which has a resiliency and which connects the fixed part and the nib. The nib of the lock spring 16PA becomes an engaged state in which it protrudes through the slit 16SL according to a movement of the curved part to be engaged with the edge defining a hole 20h as described above or an unengaged state in which it is retracted in the lock spring containing section.

The receptacle 14 includes a plug-connecting section on which the connecting portion of the plug 10 is detachably disposed and an adaptor housing 22 with an insulator which electrically connects the plug 10 to one end of the flexible wiring board 18.

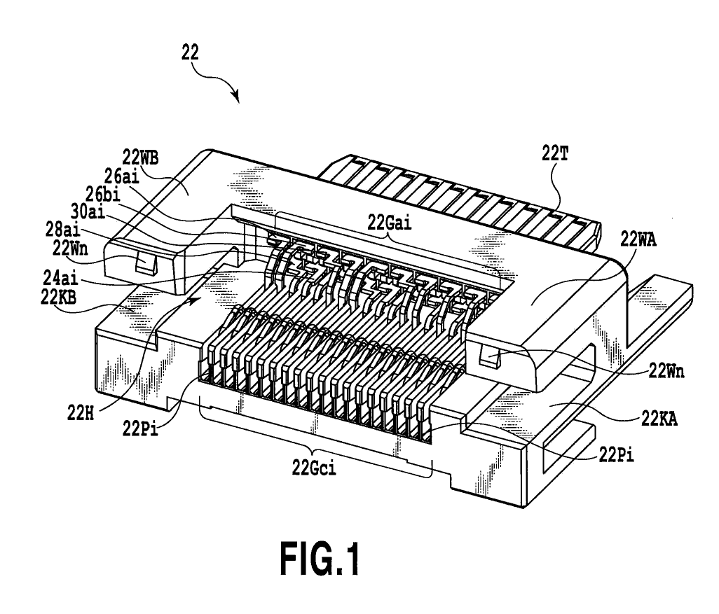

As shown in FIGS. 5A, 5B, 6, and 8, outer shells of the plug-connecting section and the adaptor housing with an insulator are formed from a shell member 20 made of a metal. The shell member 20 includes a plug support portion 20P which supports the connecting portion of the plug 10 inserted and withdrawn to and from the receptacle, a slider support portion 20R which supports the adaptor housing 22 with an insulator to be described later (see FIG. 1), and flange portions 20F which are formed continuously with the adaptor support portion 20R.

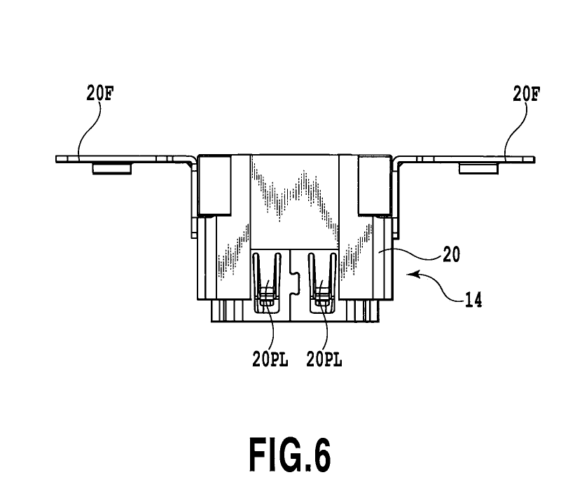

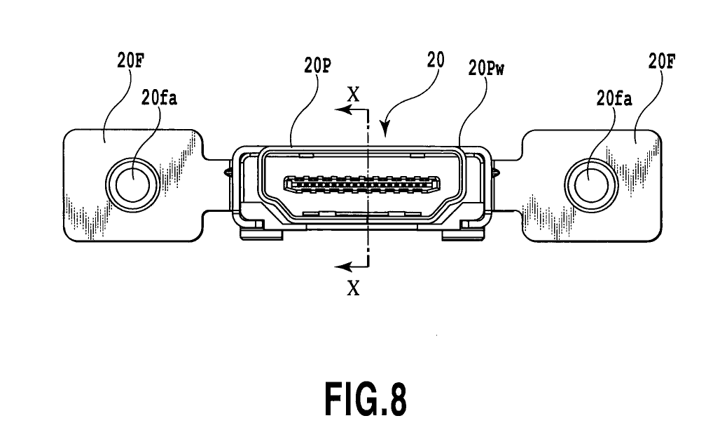

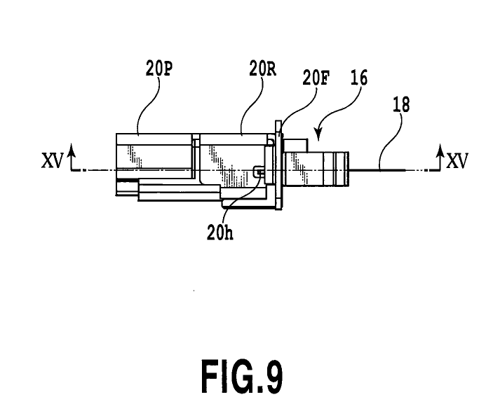

As shown in FIG. 8, the plug support portion 20P is formed in the form of a cylinder having a sectional shape which is in accordance with the sectional shape of the connecting portion of the plug 10. This causes an insertion hole for the connecting portion of the plug 10 to be formed inside the plug support portion 20P. Contact pieces 20PA and 20PB for grounding (see FIG. 5A) and locking pieces 20PL (see FIG. 6) which can be elastically displaced to hold the connecting portion of the plug 10 inserted in the receptacle are formed integrally with the shell member 20 on the top and the bottom of the plug support portion 20P, respectively. Tips of the locking pieces 20PL are engaged with depressions (not shown) formed on the connecting portion of the plug 10 when the connecting portion of the plug 10 is inserted. Tips of the contact pieces 20PA and 20PB for grounding come into contact with a metal shell of the connecting portion of the plug 10 to be grounded when the connecting portion of the plug 10 is inserted.

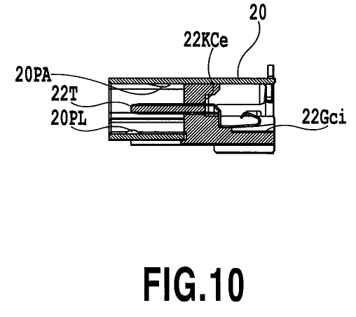

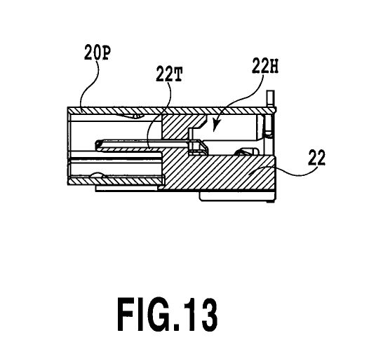

As shown in FIGS. 10 and 13, the flat sheet-like insulator portion 22T of the adaptor housing 22 is provided substantially in the middle of the interior of the plug support portion 20P so as to protrude toward an open end of the plug support portion 20P. The insulator portion 22T is detachably fitted in the slit of the connecting portion of the plug 10 described above.

The adaptor support portion 20R in the form of a gate formed adjacent to and integrally with the plug support portion 20P has a width greater than the width of the plug support portion 20P.

Therefore, the above-described plug-connecting section is formed by the insulator portion 22T which is a portion to be connected with the connecting portion of the plug 10 and the plug support portion 20P which is provided on the shell member 20.

As shown in FIG. 15, locking holes 20h are formed on both sides of the adaptor support portion 20R respectively, the holes being selectively fixed with the nibs of the above-described lock springs 16PA and 16PB when the adaptor portion 16 is mounted.

At each of the flange portions 20F, a hole 20fa into which a small screw is inserted to fix the receptacle 14 in a predetermined position in the AV equipment is formed.

In the case that each of the flange portions 20F is fixed to the housing of the AV equipment which is in conduction to, for example, a ground line using the small screw inserted through the hole 20fa, static electricity applied to the plug support portion 20P is removed through the shell member 20 and the housing. Since the adaptor support portion 20R and the plug support portion 20P are formed integrally with each other from the same metal material, an externally-connected connector having high EMI characteristics and not subject to external noises can be obtained.

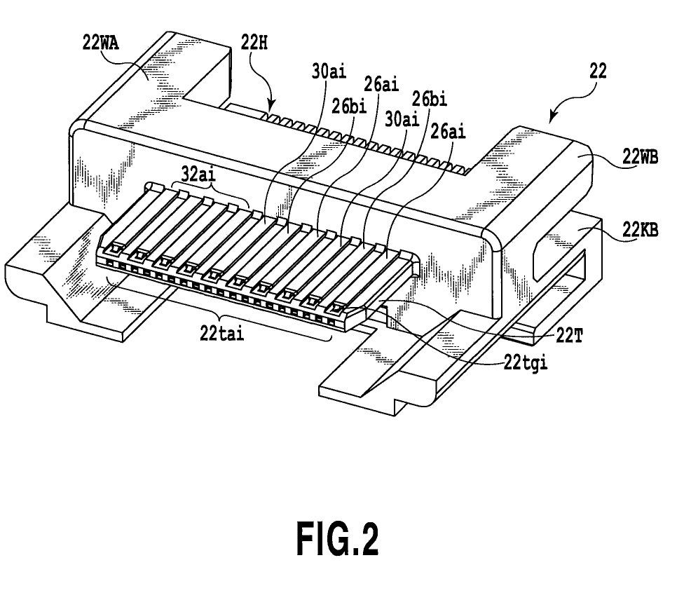

As shown enlarged in FIGS. 1, 2, and 3, the adaptor housing 22 with an insulator is integrally formed from a resin material, and the housing has the insulator portion 22T which extends perpendicularly to an end face thereof. On each of opposite sides of the sheet-like insulator portion 22T, a plurality of shallow and elongate grooves 22tgi (i=1 to n, and n is a positive integer) which a contact pad portion of each of contact terminals to be described later is disposed, are formed on a common plane at predetermined intervals in an arrangement that is orthogonal to the direction of the connecting portion of the plug 10 insertion and withdrawal.

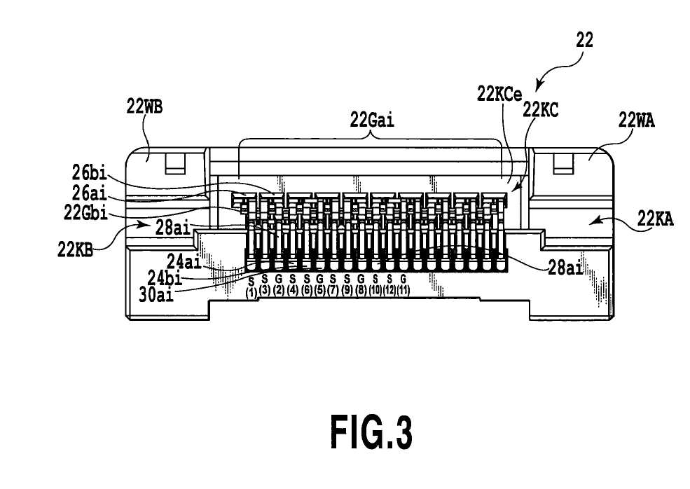

One end of each groove 22tgi extends up to a front end of the insulator portion 22T. Another end of each groove 22tgi formed on the top side of the insulator portion is in communication with a groove 22Gai (see FIGS. 1 and 3) to be described later, and another end of each groove 22tgi formed on the bottom side is in communication with a groove 22Gbi (see FIG. 3).

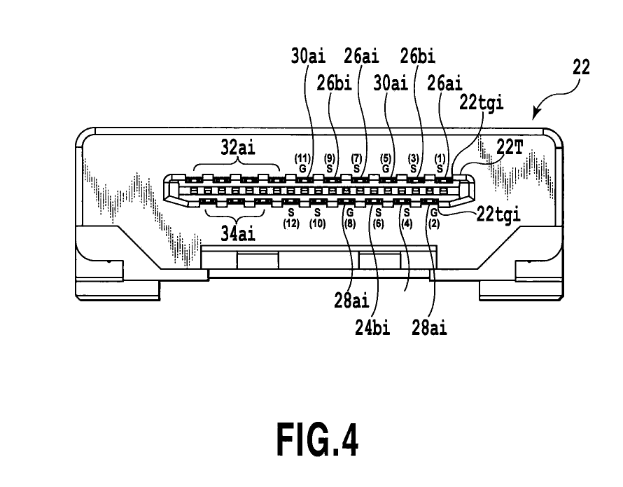

As shown in FIG. 4, one of grooves 22tgi formed on one common plane is formed to face the gap between two grooves 22tgi formed adjacent to each other on another common plane. Therefore, the groove 22tgi formed on the first common plane and the grooves 22tgi formed on the other common plane are in what is called a staggered relationship.

As shown enlarged in FIG. 1, the adaptor housing 22 with an insulator includes an adaptor receiving portion 22H which is an opening provided on another end face thereof. As shown in FIG. 3, the adaptor receiving portion 22H consists of a part 22KC into which the combining portion 16S of the adaptor portion 16 described above is inserted and parts 22KA and 22KB which are formed in communication with both sides of the part 22KC and into which the guide pins 16KA and 16KB are inserted respectively.

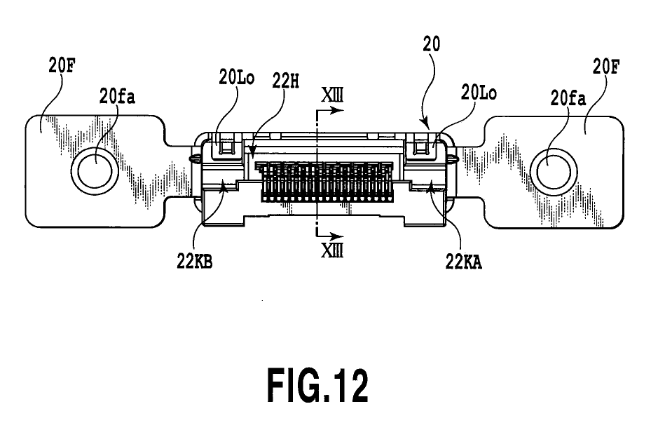

The part 22KA is formed between a top wall 22WA on the right side of the housing as shown in FIG. 3 and apart located on the right side of a bottom part of the housing where grooves 22Gci to be described later are formed. The part 22KB is formed between a top wall 22WB on the left side of the housing as shown in FIG. 3 and a part located on the left side of the bottom part where the grooves 22Gci to be described later are formed. As shown in FIG. 12, a nib 22Wn to be fixed with a locking hole 20Lo of the adaptor support portion 20R is formed at each of the tips of the top walls 22WA and 22WB.

As shown enlarged in FIGS. 3 and 10, one end of each of the grooves 22Gai and 22Gbi (i=1 to n, and n is a positive integer) which fixing portions of contact terminals 24ai and 24bi, fixing portions of contact terminals 28ai and contact terminals 30ai, and fixing portions of contact terminals 32ai and contact terminals 34ai (i=1 to n, and n is a positive integer) to be described later are fitted, opens on a terminatory end face 22KCe of the part 22KC.

The grooves 22Gai and 22Gbi are respectively formed on the common planes on which the above-described grooves 22tgi are formed. The array of the grooves 22Gai disposed in a row on one of the common planes is located above the array of the grooves 22Gbi disposed in a row on the other common plane. One groove 22Gbi is also formed to face the region between two grooves 22Gai adjacent to each other. For example, the groove 22tgi located at the right endmost end of the top surface in FIG. 4 is in communication with the groove 22Gai located at the left endmost end of the row of grooves 22Gai shown in FIG. 3. The groove 22tgi located at the right endmost end of the bottom surface in FIG. 4 is also in communication with the groove 22Gbi located at the left endmost end of the row of grooves 22Gbi shown in FIG. 3.

Further, as shown enlarged in FIG. 1, in a region inside the adaptor housing 22 with an insulator which is continuous with the terminatory end face 22KCe at the bottom of the part 22KC, a plurality of grooves 22Gci (i=1 to n, and n is a positive integer) are formed at predetermined intervals corresponding to the grooves 22Gai and 22Gbi on a common plane in the region forming the bottom of the part 22KC. Resilient pieces of the contact terminals 24ai, 24bi, 26ai, 26bi, the contact terminals 28ai and 30ai, and contact terminals 32ai and 34ai are inserted in respective grooves 22Gci.

The gap between adjacent grooves 22Gci are partitioned from each other by partition walls 22Pi (i=1 to n, and n is a positive integer). Herewith, the resilient pieces of contact terminals 24ai to 34ai are disposed on a common plane in the respective grooves 22Gci as will be described later.

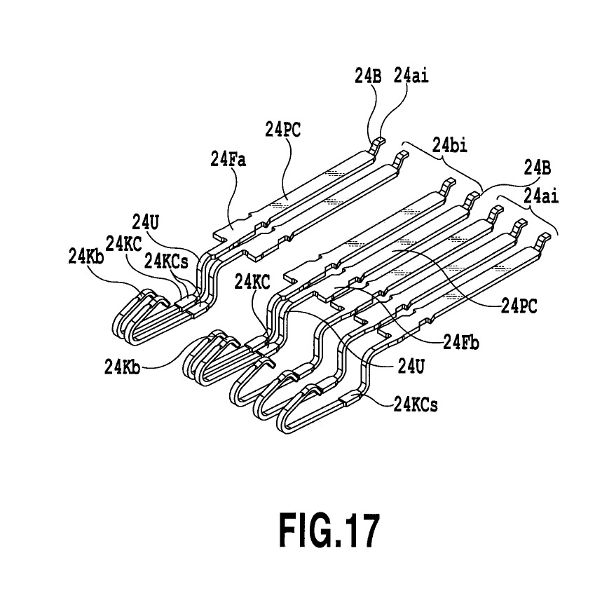

The contact terminals 24ai disposed in the grooves 22Gbi are used for signal lines and are fabricated from, for example, a thin plate of phosphor bronze. As shown enlarged in FIG. 17, each contact terminal 24ai is comprised of a contact pad portion 24PC inserted in a groove 22tgi formed on the bottom of the insulator portion 22T of the adaptor housing 22 with an insulator, a resilient piece 24KC inserted in a groove 22Gci as described above, and a fixing portion 24Fa connecting the contact pad portion 24PC to the resilient piece 24KC.

At a tip of the contact pad portion 24PC contacting a contact pin of the plug 10, a bent part 24B to be engaged with an end of the insulator portion 22T is provided. The fixing portion 24Fa is formed integrally with the contact pad portion 24PC such that the center axis of the contact pad portion extending in the longitudinal direction thereof is aligned with the center axis of the fixing portion 24Fa.

One end of a bent part 24U connecting one end of the resilient piece 24KC with the fixing portion 24Fa is connected to the fixing portion 24Fa such that the bent part is rightwardly offset from the center axis of the fixing portion 24Fa at a predetermined distance, as shown in FIG. 17. Another end of the bent part 24U is bent substantially perpendicularly to the top surface of the fixing portion 24Fa toward the underside of the fixing portion.

The resilient piece 24KC connected to the other end of the bent part 24U is bent such that the tip of the same is folded upward substantially in a U-shaped. A contact portion 24Kb which contacts a respective contact pad constituting the contact pad group 18CP of the flexible wiring board 18 is formed in the vicinity of the tip of the bent region. At fixing portion 24Fa and the resilient piece 24KC, a nib and a thick part 24KCs, respectively, are formed, the nib and a thick part for preventing the fixing portion 24Fa and the resilient piece 24KC from floating up out of the groove.

As shown enlarged in FIG. 17, the contact terminals 24bi disposed in the grooves 22Gbi are used for signal lines and are provided adjacent to the contact terminals 24ai. The contact terminals 24bi are similar to the contact terminals 24ai in configuration except for fixing portions 24Fb. A fixing portion 24Fb is formed integrally with a contact pad portion 24PC such that the center axis of the contact pad portion 24PC extending in the longitudinal direction thereof is aligned with the center axis of the fixing portion 24Fb. At that time, one end of a bent part 24U connecting one end of the resilient piece 24KC with the fixing portion 24Fb is connected to the fixing portion 24Fb such that the bent part is leftwardly offset from the center axis of the fixing portion 24Fb at a predetermined distance, as shown in FIG. 17. Another end of the bent part 24U is bent substantially perpendicularly to the top surface of the fixing portion 24Fb toward the underside surface of the fixing portion.

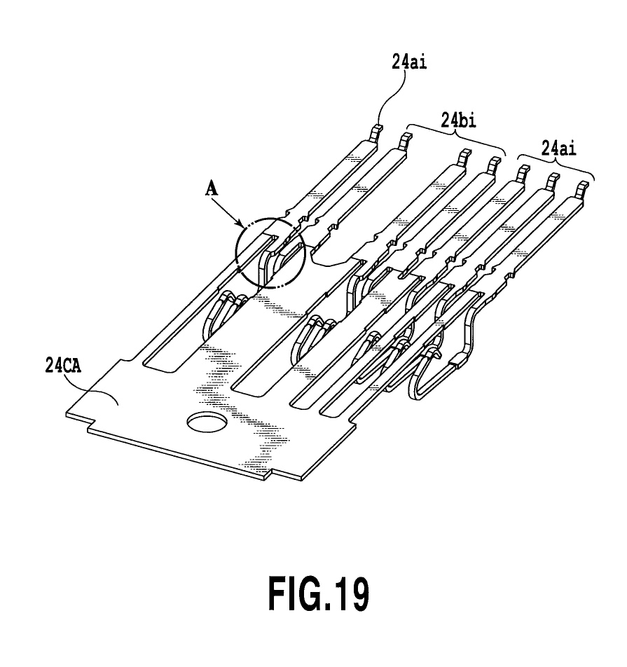

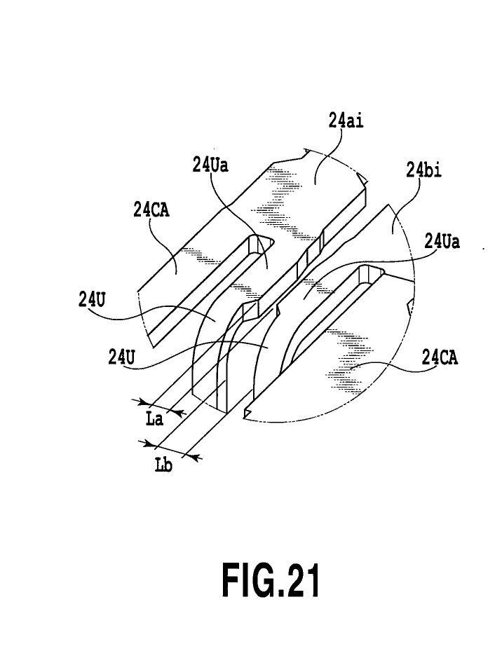

The contact terminals 24ai and the contact terminals 24bi described above are manufactured by a press molding using respective common molds, respectively. At a step of manufacturing the contact terminals 24ai and the contact terminals 24bi, as shown enlarged in FIG. 19, the terminals are also connected with each other by a carrier 24CA. At that time, as shown enlarged in FIG. 21, an enlarged part 24Ua is formed at one end of each of the bent parts 24U of a contact terminal 24ai and a contact terminal 24bi disposed adjacent to each other on the ground that a distance La between the enlarged parts 24Ua of the contact terminal 24ai and the contact terminal 24bi disposed adjacent to each other in order to facilitate an impedance matching is set to a minimum. Therefore, the distance La between the enlarged parts 24Ua of the contact terminals 24ai and 24bi disposed adjacent to each other is smaller than a distance Lb between the contact terminals measured in a position closer to the other end side of the bent part 24U, that is, the position of the adjacent enlarged parts 24Ua approach each other, as shown in FIG. 21.

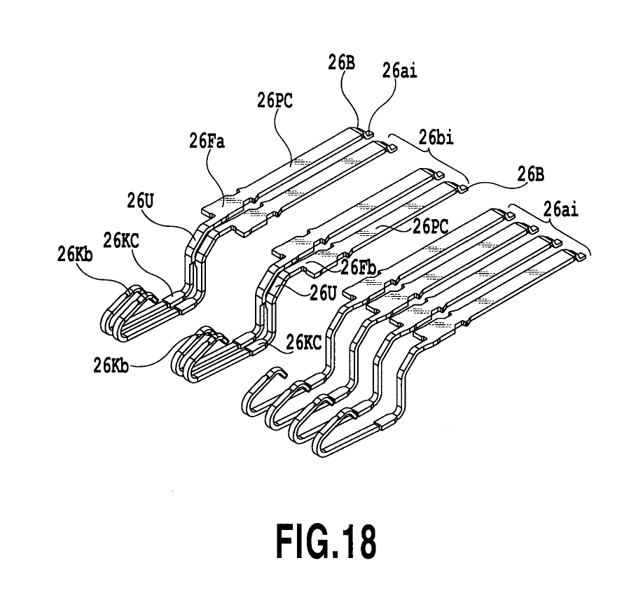

The contact terminals 26ai disposed in the grooves 22Gai are used for signal lines and are fabricated from, for example, a thin plate of phosphor bronze. As shown enlarged in FIG. 18, each contact terminal 26ai is comprised of a contact pad portion 26PC inserted in a groove 22tgi formed on the top of the insulator portion 22T of the adaptor housing 22 with an insulator, a resilient piece 26KC inserted in a groove 22Gci as described above, and a fixing portion 26Fa connecting the contact pad portion 26PC to the resilient piece 26KC.

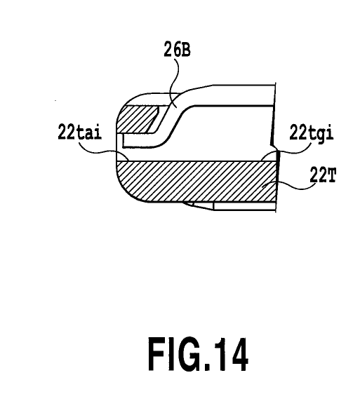

Also, a tip of the contact pad portion 26PC contacting a contact pin of the plug 10, the tip has a bent part 26B to be engaged with a circumferential edge defining a hole 22tai opening at an end of the insulator portion 22T, as shown partial enlarged in FIG. 14. Note that the hole 22tai is in communication with the groove 22tgi.

The fixing portion 26Fa is formed integrally with the contact pad portion 26PC such that the center axis of the contact pad portion extending in the longitudinal direction thereof is aligned with the center axis of the fixing portion 26Fa.

Also, one end of a bent part 26U connecting one end of the resilient piece 26KC with the fixing portion 26Fa is connected to the fixing portion 26Fa such that the bent part is rightwardly offset from the center axis of the fixing portion 26Fa at a predetermined distance, as shown in FIG. 18. Another end of the bent part 26U is bent substantially perpendicularly to the top surface of the fixing portion 26Fa toward the underside surface of the fixing portion. The length of the bent part 26U is set greater than the length of the bent parts 24U of the contact terminals 24ai and 24bi.

The resilient piece 26KC connected to the other end of the bent part 26U is bent such that the end of the same is folded upward substantially in a U-shaped. A contact portion 26Kb which contacts a respective contact pad constituting the contact pad group 18CP of the flexible wiring board 18 is formed in the vicinity of the tip of the bent region.

As shown enlarged in FIG. 18, the contact terminals 26bi disposed in the grooves 22Gai are used for signal lines and are provided adjacent to the contact terminals 26ai. The contact terminals 26bi are similar to the contact terminals 26ai in configuration except for fixing portions 26Fb. A fixing portion 26Fb is formed integrally with a contact pad portion 26PC such that the center axis of the contact pad portion 26PC extending in the longitudinal direction thereof is aligned with the center axis of the fixing portion 26Fb. At that time, one end of a bent part 26U connecting one end of the resilient piece 26KC with the fixing portion 26Fb is connected to the fixing portion 26Fb such that the bent part is leftwardly offset from the center axis of the fixing portion 26Fb at a predetermined distance, as shown in FIG. 18. Another end of the bent part 26U is bent substantially perpendicularly to the top surface of the fixing portion 26Fb toward the underside surface of the fixing portion.

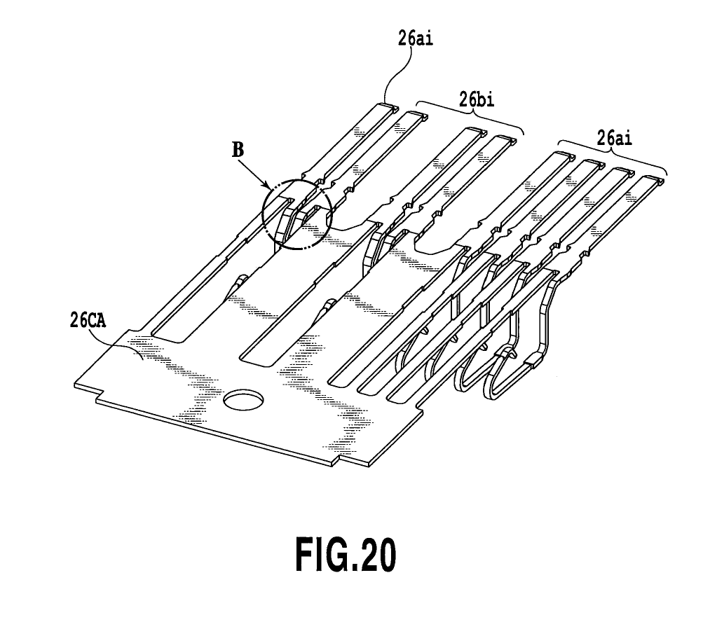

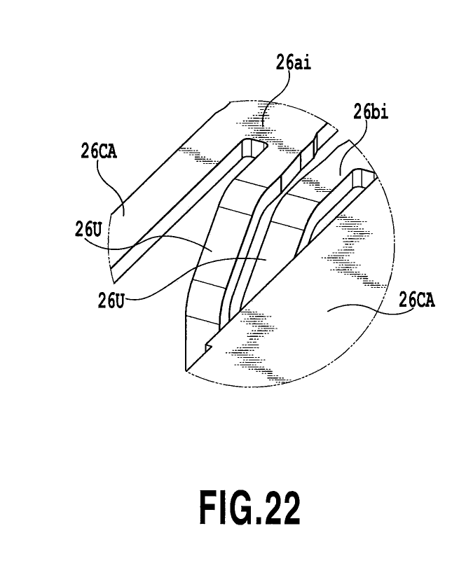

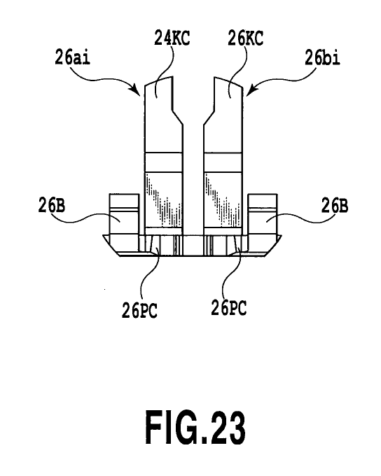

The contact terminals 26ai and the contact terminals 26bi described above are manufactured by a press molding using respective common molds, respectively. At a step of manufacturing the contact terminals 26ai and the contact terminals 26bi, as shown enlarged in FIG. 20, the terminals are connected with each other by a carrier 26CA. In that case, as shown partial enlarged in FIGS. 22 and 23, ends of the bent parts 26U of contact terminals 26ai and 26bi disposed adjacent to each other are formed in parallel at a predetermined interval from each other and are bent plural times to keep the lengths of the transmission paths small so as to extend at a predetermined angle of inclination.

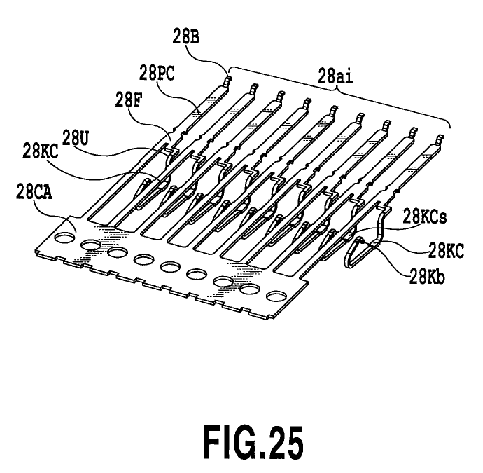

The contact terminals 28ai disposed in the grooves 22Gbi are used for grounding lines and are fabricated from, for example, a thin plate of phosphor bronze. As shown enlarged in FIG. 25, each terminal is comprised of a contact pad portion 28PC inserted in a groove 22tgi formed on the bottom of the insulator portion 22T of the adaptor housing 22 with an insulator, a resilient piece 28KC inserted in a groove 22Gci as described above, and a fixing portion 28F connecting the contact pad portion 28PC to the resilient piece 28KC. FIG. 25 shows a state of manufacturing step for the contact terminals 28ai along with a carrier 28CA.

A tip of the contact pad portion 28PC contacting a contact pin of the plug 10 has a bent part 28B to be engaged with an end of the insulator portion 22T. The fixing portion 28F is formed integrally with the contact pad portion 28PC such that the center axis of the contact pad portion extending in the longitudinal direction thereof is aligned with the center axis of the fixing portion 28F.

One end of a bent part 28U connecting one end of the resilient piece 28KC with the fixing portion 28F is connected to the fixing portion 28F such that the bent part is rightwardly offset from the center axis of the fixing portion 28F at a predetermined distance, as shown in FIG. 25. Another end of the bent part 28U is bent substantially perpendicularly to the top surface of the fixing portion 28F toward the underside surface of the fixing portion.

The resilient piece 28KC connected to the other end of the bent part 28U is bent such that the tip of the same is folded upward substantially in a U-shaped. A contact portion 28Kb which contacts a respective contact pad constituting the contact pad group 18CP of the flexible wiring board 18 is formed in the vicinity of the tip of the bent region. At the fixing portion 28F and the resilient piece 28KC, a nib and a thick part 28KCs, respectively, for preventing the fixing portion 28F and the resilient piece 28KC from floating up out of the groove are formed.

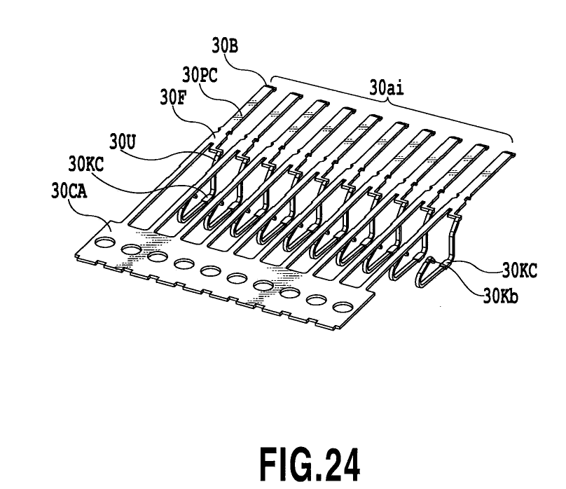

The contact terminals 30ai disposed in the grooves 22Gai are used for grounding lines and are fabricated from, for example, a thin plate of phosphor bronze. As shown enlarged in FIG. 24, each contact terminal is comprised of a contact pad portion 30PC inserted in a groove 22tgi formed on the top of the insulator portion 22T of the adaptor housing 22 with an insulator, a resilient piece 30KC inserted in a groove 22Gci as described above, and a fixing portion 30F connecting the contact pad portion 30PC to the resilient piece 30KC. FIG. 24 shows a state of manufacturing step for the contact terminals 30ai along with a carrier 30CA.

A tip of the contact pad portion 30PC contacting a contact pin of the plug 10 has a bent part 30B.

The fixing portion 30F is formed integrally with the contact pad portion 30PC such that the center axis of the contact pad portion extending in the longitudinal direction thereof is aligned with the center axis of the fixing portion 30F.

One end of a bent part 30U connecting one end of the resilient piece 30KC with the fixing portion 30F is connected to the fixing portion 30F such that the bent part is rightwardly offset from the center axis of the fixing portion 30F at a predetermined distance, as shown in FIG. 24. Another end of the bent part 30U is bent substantially perpendicularly to the top surface of the fixing portion 30F toward the underside surface of the fixing portion. The length of the bent part 30U is set greater than the length of the bent parts 28U of the contact terminals 28ai.

The resilient piece 30KC connected to the other end of the bent part 30U is bent such that the tip of the same is folded upward substantially in a U-shaped. A contact portion 30Kb which contacts a respective contact pad constituting the contact pad group 18CP of the flexible wiring board 18 is formed in the vicinity of the tip of the bent region.

In addition to the contact terminals 24ai to 30ai as described above, contact terminals 32ai (not shown) and contact terminals 34ai (not shown) are also disposed in the grooves 22tgi, 22Gai, and 22Gbi formed on the insulator portion 22T.

For example, in the case of Type A of HDMI standard (registered trademark), (Version 1.3) as described above, contact terminals disposed in the grooves 22tgi formed on the top surface of the insulator portion 22T are connected with signal (data and clock) lines S(1), S(3), S(7), and S(9) and grounding (shield) lines G(5) and G(11), respectively, as shown enlarged in FIG. 4. A CEC line, an SCL line, a DDC/CEC line, and a hot plug detect line are sequentially connected to a plurality of contact terminals 32ai adjacent to the grounding line 11, respectively. Therefore, the pair of signal lines S(1) and S(3) and the pair of signal lines S(7) and S(9) are disposed side by side on both sides of the grounding line G(5). In FIGS. 3 and 4, the numbers (1) to (12) represent line number (connector pin numbers). The characters S and G represent the positions of signal lines and grounding lines, respectively.

Contact terminals disposed in the grooves 22tgi formed on the bottom surface of the insulator portion 22T are connected with signal lines S(4), S(6), S(10), and S(12) and grounding lines G(2) and G(8), respectively. An auxiliary (unconnected) line, an SDA line, and a power supply line are sequentially connected to a plurality of contact terminals 34ai adjacent to the signal line S(12), respectively. Therefore, the pair of signal lines S(4) and S(6) and the pair of signal lines S(10) and S(12) are disposed side by side on both sides of the grounding line G(8).

Referring to FIG. 3, contact terminals 26ai and 26bi connected to the pair of signal lines S(1) and S(3), a contact terminal 28ai connected to the grounding line G(2), contact terminals 24ai and 24bi connected to the pair of signal lines S(4) and S(6), a contact terminal 30ai connected to the grounding line G(5), contact terminals 26ai and 26bi connected to the pair of signal lines S(7) and S(9), a contact terminal 28ai connected to the grounding line 8, contact terminals 24ai connected to the pair of signal lines S(10) and S(12), and a contact terminal 30ai connected to the grounding line G(11) are disposed in the grooves 22Gci in order from the left end.

Therefore, since each of the distances between the pair of signal lines S(1) and S(3), between the pair of signal lines S(4) and S(6), between the pair of signal lines S(7) and S(9), and between the signal lines S(10) and S(12) is equal to the pitch of the contact pad portions of the insulator portion 22T, impedance matching can be easily achieved.

For example, when the adaptor section 16 is connected to the adaptor receiving portion 22H of the receptacle 14 disposed in an AV equipment in such a configuration, the operating portions 16A and 16B are pressed in the directions indicated by the arrows shown in FIG. 15, and the combining portion 16S is inserted in the adaptor receiving portion 22H. Thereafter, the operating portions 16A and 16B are released.

Hereby, since the nib of the lock spring 16PA is consequently fixed with the circumferential edge defining the hole 20h, the adaptor section 16 is locked relative to the receptacle 14. On the contrary, referring to the removal of the adaptor section 16, while pressing the operating sections 16A and 16B in the directions indicated by the arrows shown in FIG. 15 the same way as described above, the combining portion 16S are removed from the adaptor receiving portion 22H. As a result, the adaptor section 16 is removed.

For example, when the connecting portion of the plug 10 is connected to the insulator portion 22T of the plug-connecting section exposed at a peripheral part of the AV equipment, after the connecting portion is disposed such that the slit of the same faces the insulator portion 22T each other, the connecting portion of the plug 10 is inserted into the plug support portion 20P to be connected with the insulator portion 22T. At that time, the locking peaces 20PL are engaged with respective recesses (not shown) on the connecting portion, and the connecting portion of the plug 10 is thereby locked relative to the plug support portion 20P. On the contrary, referring to the removal of the connecting portion of the plug 10, the connecting portion of the plug 10 is pulled out from the insulator portion 22T against the resilient force of the locking pieces 20PL. Thus, the plug 10 is easily removed.

Accordingly, wherever in an AV equipment the receptacle 14 is disposed, the adaptor section 16 and the flexible wiring board 18 allow the receptacle 14 to be properly connected regardless of the distance of the same from a predetermined control circuit board, thereby being able to increase a design flexibility in relation to layout of the receptacle 14.

Further, with the handling of the plug 10 by a common user, for example, when the receptacle 14 is also broken as a result of miss-insertion of the plug 10 into the receptacle, there is no need for replacing the connector for a cable based on the HDMI standard and the circuit board mounting the connector at the same time as encountered in a connector repairing operations in the related art. In addition, since the repair can be easily completed by replacing only the receptacle 14, burdens on common users placed by maintenance operations can be reduced, and also, thereby leading to a reduction in the number of wasted components.

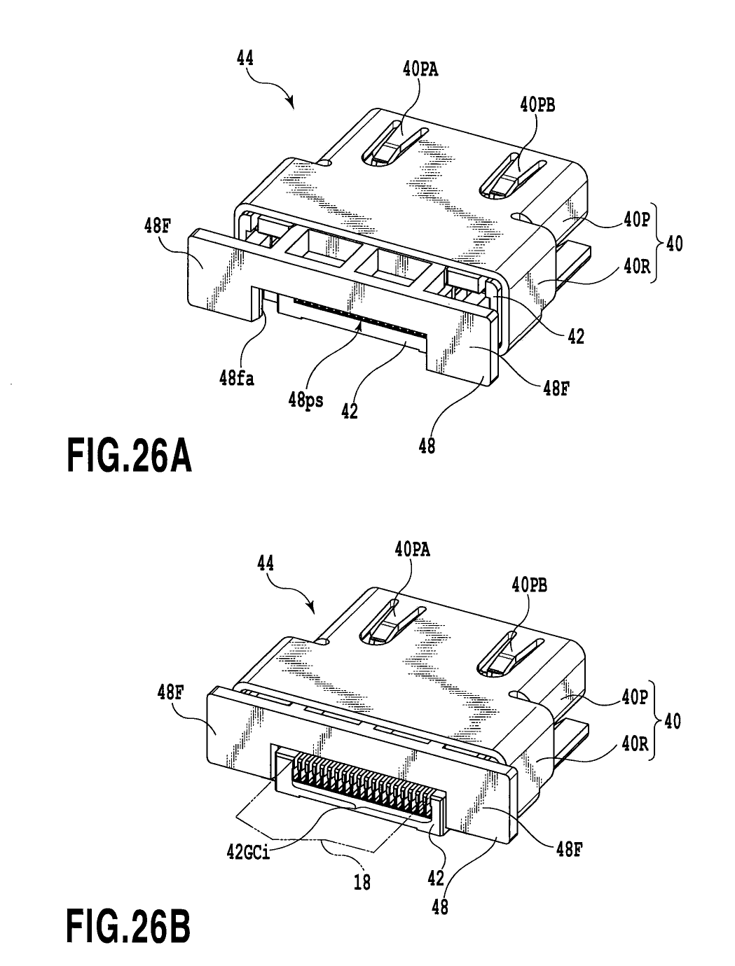

FIGS. 26A and 26B show a configuration of a second embodiment of a connector for a cable based on the HDMI standard according to the invention.

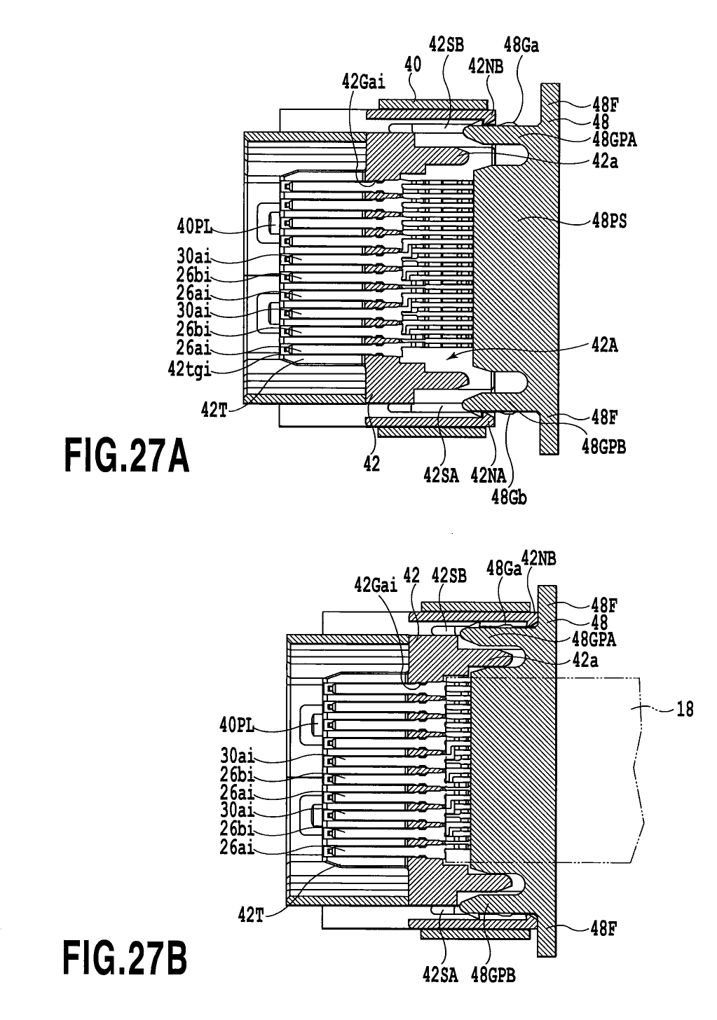

The first embodiment shown in FIGS. 5A and 5B has a configuration in which one end of a flexible wiring board 18 is indirectly connected to a receptacle 14 through an adaptor section 16. In the second embodiment of the invention, a receptacle 44 has a slider for locking and unlocking to allow one end of the flexible wiring board 18 to be directly connected with the receptacle 44 in a detachable manner. In FIGS. 26A, 26B, 27A, and 27B, elements identical to elements of the embodiment shown in FIGS. 1 and 5A are indicated by like reference numerals to avoid duplicated description. The connector of the present embodiment is also based on the definition of either Type A or Type B of the HDMI (High-Definition Multimedia Interface (registered trademark)) standard Version 1.3.

Referring to FIGS. 26A and 26B, the connector includes a receptacle 44 having a housing 42 with an insulator. The housing 42 with an insulator includes a cable-connecting section to which one end of a flexible wiring board 18 is connected and a plug-connecting section to which a connecting portion of a plug 10 as described above is detachably connected.

A shell member 40 made of a metal constitutes outer shells of the plug-connecting section and the adaptor housing with an insulator. The shell member 40 includes a plug support portion 40P which supports the connecting portion of the plug 10 attached and detached to and from the receptacle and a slider support portion 40R which supports the housing 42 with an insulator to be described later.

The plug support portion 40P is formed like a cylinder having a sectional shape which is in accordance with the sectional shape of the connecting portion of the plug 10. Thus, an insertion hole for the connecting portion of the plug 10 is formed inside the plug support portion 40P. Contact pieces 40PA and 40PB for grounding and locking pieces 40PL (see FIGS. 27A and 27B) which can be elastically displaced to hold the connecting portion of the plug 10 inserted in the receptacle are formed integrally with the shell member 40 on the top and bottom of the plug support portion 40P, respectively. Ends of the locking pieces 40PL are engaged with recesses (not shown) formed on the connecting portion of the plug 10 when the connecting portion of the plug 10 is inserted. Ends of the contact pieces 40PA and 40PB for grounding come into contact with a metal shell of the connecting portion of the plug 10 to be grounded when the connecting portion of the plug 10 is inserted.

As shown in FIGS. 27A and 27B, the insulator portion 42T in the form of a flat plate of the housing 42 with an insulator is provided substantially in the middle of the interior of the plug support portion 40P so as to protrude toward an open end of the plug support portion 40P. The insulator portion 42T is detachably fitted in a slit of the connecting portion of the plug 10 described above.

The slider support portion 40R in the form of a gate formed adjacent to and integrally with the plug support portion 40P has a width greater than the width of the plug support portion 40P.

Therefore, the above-described plug-connecting section is formed by the insulator portion 42T which is a portion to be connected with the connecting portion of the plug 10 and the plug support portion 40 which is provided on the shell member 40.

Since the slider support portion 40R and the plug support portion 40P are formed integrally with each other from the same metal material, a connector for external connection having high EMI characteristics and high resistance to external noises can be obtained.

The housing 42 with an insulator is integrally formed from a resin material, and the housing has the insulator portion 42T which extends perpendicularly to an end face thereof. On each of opposite sides of the sheet-like insulator portion 42T, a plurality of shallow and elongate grooves 42tgi (i=1 to n, and n is a positive integer) are formed on a common plane at predetermined intervals in an arrangement that is orthogonal to the direction in which the connecting portion of the plug 10 is mounted and removed, a contact pad portion of each contact terminal being disposed in each of the grooves.

One end of each groove 42tgi extends up to a front end of the insulator portion 42T. Another end of each groove 42tgi formed on the top side of the insulator portion is in communication with a groove 42Gai (i=1 ton, and n is a positive integer) and another end of each groove 42tgi formed on the bottom side is in communication with a groove (not shown) located under the groove 42Gai.

One of grooves 42tgi formed on one common plane is formed to face the gap between two grooves 42tgi formed adjacent to each other on another common plane. Therefore, the groove 42tgi formed on the first common plane and the grooves 42tgi formed on the other common plane are in what is called a staggered relationship.

The housing 42 with an insulator includes a cable-connecting section 42A which is an opening at another end face thereof. A slider 48 is slidably disposed at the cable-connecting section 42A. The slider 48 selectively locks or unlocks one end of the flexible wiring board 18 relative to the cable-connecting section 42A. As shown in FIGS. 27A and 27B, the slider 48 includes a pressing portion 48P which is provided in the middle thereof and which has a pressing surface 48PS for pressing contact pads formed at one end of the flexible wiring circuit board 18 toward a group of contact terminals. Nibs 48GPA and 48GPB are formed on both sides of the pressing portion 48P at a predetermined interval from each other. A laterally protruding operating portion 48F is formed at each of regions where the nibs 48GPA and 48GPB are connected with the pressing portion 48P. As shown in FIG. 26A, a cutout 48fa is formed between the operating portions 48F to allow an end of the cable-connecting section 42A to pass.

Guide walls 42a for guiding two respective side surfaces of the pressing portion of the slider 48 to be described later are formed at an open end of the cable-connecting section 42A. Locking nibs 42NA and 42NB are formed integrally with the housing 42 having an insulator such that they can be elastically displaced between the guide walls 42a and inner circumferential parts of the slider support portion 40R. The locking nibs 42NA and 42NB are engaged with the nibs 48GPA and 48GPB of the slider 48, respectively, at one end thereof to lock the slider 48.

Slits 42SA and 42SB are provided at respective gaps between the locking nib 42NA and one of the guide walls 42a and between the locking nib 42NB and the other guide wall 42a so as to extend in the thickness direction of the flexible wiring board 18.

On an end face of the cable-connecting section 42A located inside the connector, ends of a plurality of grooves 42Gai are exposed to be fitted with fixing portions of contact terminals 24ai and 24bi, fixing portions of contact terminals 26ai and 26bi, contact terminals 28ai, and contact terminals 30ai, and fixing portions of contact terminals 32ai and contact terminals 34ai. The grooves 42Gai are formed on a plane that is common to the grooves 42tgi described above. Although not shown, an array of grooves similar to the array of grooves 42Gai is formed under the grooves 42Gai such that the arrays are in a staggered relationship with each other.

At the bottom of the cable-connecting section 42A, a plurality of grooves 42Gci (i=1 to n, and n is a positive integer) are formed at predetermined intervals on a common plane, resilient pieces of the above described contact terminals 24ai, 24bi, and etc. being disposed in each groove. Pairs of adjacent grooves 42Gci are partitioned from each other by partition walls.

The arrangements of the contact terminals 24ai and 24bi, the contact terminals 26ai and 26bi, the contact terminals 28ai, the contact terminals 30ai, the contact terminals 32ai, and the contact terminals 34ai are the same as the arrangements in the first embodiment.

Like the first embodiment, contact terminals 26ai and 26bi connected to a pair of signal lines S(1) and S(3), a contact terminal 28ai connected to a grounding line G(2), contact terminals 24ai and 24bi connected to a pair of signal lines S(4) and S(6), a contact terminal 30ai connected to a grounding line G(5), contact terminals 26ai and 26bi connected to a pair of signal lines S(7) and S(9), a contact terminal 28ai connected to a grounding line G(8), a contact terminals 24ai connected to a pair of signal lines S(10) and S(12), and a contact terminal 30ai connected to a grounding line G(11) are disposed in the order listed in the grooves 42Gci starting at the groove at the left end in FIG. 26B.

Therefore, each of the distances between the pair of signal lines S(1) and S(3), between the pair of signal lines S(4) and S(6), between the pair of signal lines S(7) and S(9), and between the pair of signal lines S(10) and S(12) is equal to the distance between the contact pad portions of the insulator portion 42T. Thus, impedance matching can be easily achieved.

For example, when one end of the flexible wiring board 18 is connected to the cable-connecting section 42A of the receptacle 44 disposed in an AV equipment in such a configuration, the slider 48 is first in the unlocked state in which the operating portions 48F thereof are apart from the opening end of the cable-connecting section 42A as shown in FIG. 27A. Then, one end of the flexible wiring board 18 is inserted below the pressing surface 48P of the slider 48. Thereafter, the operating portions 48F of the slider 48 are pressed a predetermined distance against an urging force of the resilient pieces of the contact terminals as shown in FIG. 27B to lock the slider 48.

Referring to the removal of the end of the flexible wiring board 18, the operating portions 48F of the slider 48 are pulled away from the open end of the cable-connecting section 42A to be unlocked as described above, and the end of the flexible wiring board 18 is thereby removed.

For example, to connect the connecting portion of the plug 10 with the insulator portion 42T of the plug-connecting section exposed at a peripheral part of an AV equipment, the same operation as in the first embodiment is carried out.

The present embodiment provides the same effects and advantages as those of the first embodiment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A connector for a cable based on the HDMI standard comprising:
a cable connecting portion to which a group of contact pads of a flexible cable are detachably connected directly or indirectly;
a first transmission path forming surface and a second transmission path forming surface which a plurality of transmission paths are respectively arranged according to the HDMI standard on a plug-portion being connected to which a connecting portion of a plug connected with a cable based on the HDMI standard is detachably connected;
a first contact terminal for grounding and a second contact terminal for grounding connected to one transmission path for grounding formed between a pair of transmission paths for signals and another pair of transmission paths for signals on each of said first transmission path forming surface and said second transmission path forming surface, said first contact terminal for grounding and said second contact terminal for grounding for electrical connecting with the cable;
a first contact terminal for signals and a second contact terminal for signals connected to a pair of transmission paths for signals, respectively, on said first transmission path forming surface, said first contact terminal for signals and said second contact terminal for signals for electrical connecting with the cable; and
a third contact terminal for signals and a fourth contact terminal for signals connected to a pair of transmission paths for signals, respectively, on said second transmission path forming surface, said third contact terminal for signals and said fourth contact terminal for signals for electrical connecting with the cable,
wherein a contact portion of said first contact terminal for signals and a contact portion of said second contact terminal for signals are disposed adjacent to each other on a common plane of said cable-connecting portion, and a contact portion of said third contact terminal for signals and a contact portion of said fourth contact terminal for signals are disposed adjacent to each other on common plane of said cable-connecting portion,
wherein a contact portion of said second contact terminal for grounding is disposed between either the contact portion of said first contact terminal for signals or the contact portion of said second contact terminal for signals and either the contact portion of said third contact terminal for signals or the contact portion of said fourth contact terminal for signals.

2. A connector for a cable based on the HDMI standard comprising:
a cable connecting portion to which a group of contact pads of a flexible cable are detachably connected directly or indirectly;
a first transmission path forming surface and a second transmission path forming surface which a plurality of transmission paths are respectively arranged according to the HDMI standard on a plug-portion being connected to which a connecting portion of a plug connected with a cable based on the HDMI standard is detachably connected;
a first contact terminal for grounding and a second contact terminal for grounding connected to one transmission path for grounding formed between a pair of transmission paths for signals and another pair of transmission paths for signals on each of said first transmission path forming surface and said second transmission path forming surface, said first contact terminal for grounding and said second contact terminal for grounding for electrical connecting with the cable;
a first contact terminal for signals and a second contact terminal for signals connected to a pair of transmission paths for signals, respectively, on said first transmission path forming surface, said first contact terminal for signals and said second contact terminal for signals for electrical connecting with the cable; and
a third contact terminal for signals and a fourth contact terminal for signals connected to a pair of transmission paths for signals, respectively, on said second transmission path forming surface, said third contact terminal for signals and said fourth contact terminal for signals for electrical connecting with the cable,
wherein a contact portion of said first contact terminal for signals and a contact portion of said second contact terminal for signals are disposed adjacent to each other on a common plane of the cable-connecting portion, and a contact portion of said third contact terminal for signals and a contact portion of said fourth contact terminal for signals are disposed adjacent to each other on another common plane of the cable-connecting portion, and
a contact portion of said first contact terminal for grounding is disposed between either the contact portion of said first contact terminal for signals or the contact portion of said second contact terminal for signals and either the contact portion of said third contact terminal for signals or the contact portion of said fourth contact terminal for signals, or the contact portion of said first contact terminal for grounding being disposed adjacent to the contact portion of either said third contact terminal for signals or said fourth contact terminal for signals.

3. A connector for a cable based on the HDMI standard comprising:
said second contact terminal for grounding according to claim 1 and said first contact terminal for grounding according to claim 2.

4. A connector for a cable based on the HDMI standard according to claim 1, wherein a transmission path connected to said transmission path for grounding is formed on both sides of a pair of transmission paths connected to said pair of signal transmission paths on a common plane of said cable-connecting portion.

5. A connector for a cable based on the HDMI standard according to claim 1, wherein said cable-connecting portion and said plug-portion being connected are integrally formed from a resin material and wherein an outer shell having a fixing means, for supporting said cable-connecting portion and said plug-portion being connected is molded of a metal material.

6. A connector for a cable based on the HDMI standard according to claim 1, wherein an enlarged part is formed at one end of each of bent parts of said first contact terminal for signals and said second contact terminal for signals disposed adjacent to each other and wherein the distance between the enlarged parts of said first contact terminal for signals and said second contact terminal for signals is set smaller than the distance between other parts of the bent parts.

7. A connector for a cable based on the HDMI standard according to claim 1, wherein ends of bent parts of said first contact terminal for signals and said second contact terminal for signals disposed adjacent to each other are formed in parallel at a predetermined interval from each other and are bent plural times to keep the lengths of the transmission paths small so as to extend at a predetermined angle of inclination.

8. A connector for a cable based on the HDMI standard according to claim 2, wherein a transmission path connected to said transmission path for grounding is formed on both sides of a pair of transmission paths connected to said pair of signal transmission paths on a common plane of said cable-connecting portion.

9. A connector for a cable based on the HDMI standard according to claim 2, wherein an enlarged part is formed at one end of each of bent parts of said first contact terminal for signals and said second contact terminal for signals disposed adjacent to each other and wherein the distance between the enlarged parts of said first contact terminal for signals and said second contact terminal for signals is set smaller than the distance between other parts of the bent parts.

10. A connector for a cable based on the HDMI standard according to claim 2, wherein ends of bent parts of said first contact terminal for signals and said second contact terminal for signals disposed adjacent to each other are formed in parallel at a predetermined interval from each other and are bent plural times to keep the lengths of the transmission paths small so as to extend at a predetermined angle of inclination.

11. A connector for a cable based on the HDMI standard according to claim 3, wherein a transmission path connected to said transmission path for grounding is formed on both sides of a pair of transmission paths connected to said pair of signal transmission paths on a common plane of said cable-connecting portion.

12. A connector for a cable based on the HDMI standard according to claim 3, wherein an enlarged part is formed at one end of each of bent parts of said first contact terminal for signals and said second contact terminal for signals disposed adjacent to each other and wherein the distance between the enlarged parts of said first contact terminal for signals and said second contact terminal for signals is set smaller than the distance between other parts of the bent parts.

13. A connector for a cable based on the HDMI standard according to claim 3, wherein ends of bent parts of said first contact terminal for signals and said second contact terminal for signals disposed adjacent to each other are formed in parallel at a predetermined interval from each other and are bent plural times to keep the lengths of the transmission paths small so as to extend at a predetermined angle of inclination.
